(19) United States
(12) Patent Application Publication
(10) Pub. No.: US 2009/0083221 A1
(43) Pub. Date: Mar. 26, 2009

(54) System and Method for Estimating and Storing Skills for Reuse

(75) Inventors: Gopal S. Pingali, Mohegan Lake, NY (US); Mark E. Podlaseck, Kent, CT (US); Maja Vukovic, New York, NY (US)

Correspondence Address: CAHN & SAMUELS, LLP, 1100 17th STREET, NW, SUITE 401, WASHINGTON, DC, 20036, US

(73) Assignee: INTERNATIONAL BUSINESS MACHINES CORPORATION, Armonk, NY (US)

(21) Appl. No.: 11/859,509

(22) Filed: Sep. 21, 2007

(51) Int. Cl. G06F 17/30

(52) U.S. Cl. 707/3; 705/9; 707/6

(57) ABSTRACT

A system and method that automatically estimates and chronicles the skills of an individual creating a database of skills that are dynamically updated, and enables the search and viewing of skills along multiple dimensions and at the desired level of detail. The system also provides the playback or reuse of skills such that best practices may be implemented manually or automatically to resolve current problems, and facilitate training and transitioning of resources in order to effectively optimize workforce management. Further, the system automatically reallocates or makes suggestions for the reallocation of resources to meet service level agreement requirements.

### I. FIELD OF THE INVENTION

This invention relates generally to service delivery operations in the field of information technology (IT) and, more specifically to a system and method that automatically estimates the skills of an individual, creates a rich database of skills that are dynamically updated, and enables the search and viewing of skills along multiple dimensions including relevant time periods, relevant skill areas, location, activity type, and at the desired level of detail (granularity/abstraction) in order to effectively optimize workforce management.

### II. BACKGROUND OF THE INVENTION

In a dynamic and fast-paced business environment it is often vital that businesses be able to quickly and effectively deliver services. An important component of service delivery operations involves maintaining a database of skills associated with individual service providers. Skills databases aid in the management of skills and workforces by keeping track of the available skills and resources available at a given time. This enables the assignment of appropriately skilled providers to projects and tasks based on individual skill sets and proficiencies. Skills databases also serve other important functions, such as indicating which skills need to be replaced due to attrition and providing a means for the re-allocation of skills due to emergencies or disasters. These functions act to support resiliency in workforce management operations.

One problem presented is that creating such a database can be a manual, time-consuming process. This process typically requires entries to be manually entered into the skills database, for example, entering records such as a resume listing particular skills and associated experience levels for each skill. While this type of process provides some value in indicating and assessing available skills it fails to accurately reflect the presently available skill set of individual providers as proficiencies and knowledge change over time.

Another problem presented is this process relies on a subjective description and quantification of skills when entered into the database, i.e., the provider's purported skill and experience level as indicated on the resume. These descriptions are often generic and lack sufficient detail in regards to level of expertise, most recent experience, time spent on different projects and tools, etc. to accurately catalog the skills. These deficient descriptions lead to inconsistencies in the description and level of individual and overall skill sets and tend to result in inefficiency through mismatched or less than optimal management of skills.

Another drawback is that these skills databases do not facilitate the re-use of skills and expertise of one person by another person in a similar situation.

### III. SUMMARY OF THE INVENTION

In an exemplary embodiment the present invention provides a data processing method, including retrieving captured activities from a database based on selected criteria; determining skills associated with said activities; determining parameters for said skills based on said activities; and dynamically storing said updated skills in a database.

In another exemplary embodiment the present invention provides a method for estimating and chronicling the skills of an individual, including retrieving captured activities from a database based on selected criteria; creating a list of skills for said selected criteria; determining skills associated with said activities; determining parameters for said skills based on said activities; updating said skills based on said parameters and associated activities; and dynamically storing said updated skills in a database.

In yet another exemplary embodiment the present invention provides a computer program product including a computer useable medium including a computer readable program, wherein the computer readable program when executed on a computer causes the computer to capture activities performed by at least one user to resolve said problem; chronicle said captured activities; and estimate the skill of said at least one user based on said captured activities.

In still another exemplary embodiment the present invention provides a system for estimating and chronicling the skills of an individual, including at least one database for storing captured activities; means for obtaining selection criteria; means for retrieving captured activities from said database based on said selection criteria; means for determining skills associated with said activities; means for determining parameters for said skills based on said activities; and means for dynamically storing said updated skills in said at least one database.

The present invention dynamically estimates and chronicles the skill set and level of individual service providers in a skill repository to provide a current database of all available skills that is searchable along multiple dimensions, e.g., time, skill areas, locations, activity types, and level of detail (granularity/abstraction), as well as providing summaries of best practices that can be replayed to facilitate resolving current problems, training, and transitioning of resources. The system also automatically reallocates or makes suggestions for the reallocation of resources to meet service level agreement requirements.

### IV. BRIEF DESCRIPTION OF THE DRAWINGS

The present invention is described with reference to the accompanying drawings, wherein:

FIG. 1 illustrates a flow chart representing a role replay and training system in accordance with an exemplary embodiment of the present invention.

FIG. 2 illustrates a skills and activities capturing system in accordance with an exemplary embodiment of the present invention.

FIGS. 3A-B illustrate, in two parts, a flowchart outlining an exemplary skill extraction and activity association process in accordance with the present invention.

FIG. 4 illustrates exemplary cluster bars in accordance with the present invention.

FIG. 5 illustrates a flowchart outlining an exemplary chronicled activities clustering process in accordance with the present invention.

Given the following enabling description of the drawings, the apparatus should become evident to a person of ordinary skill in the art.

### V. DETAILED DESCRIPTION OF THE DRAWINGS

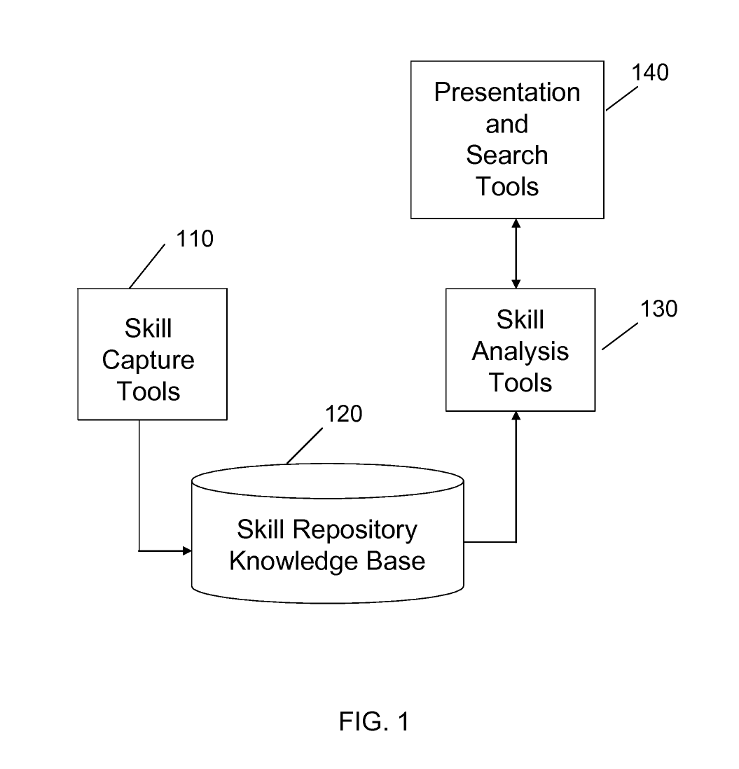

The present invention will be described in help desk environment and its advantages are best understood by referring to FIGS. 1-5. The system and method of the present invention automatically estimates and catalogs the skills of an individual which enables the system to create a rich database of skills that is dynamically updated. The system allows users to search and view skills in a skill repository (knowledge base) along multiple dimensions of interest including, for example, during certain time periods, within relevant skill areas, and at any desired level of detail.

The present invention offers several benefits in the area of workforce management such as supporting the real-time summary of operations, supporting the dynamic reallocation of skills, improving skills training, advancing the resiliency of the skills and workforce, and sustaining a real-time summary of operations to ensure an authentic outline of the resources available for a particular problem, issue or topic of interest. These resources may specify a catalog of subject matter experts, including other detail such as their location and efficiency rating, recent solutions for a current problem, as well as a summary or role replay of the procedures (best practices) used to resolve the problems.

The dynamic reallocation of skills as outlined in the present invention helps to optimize overall efficiency. The reallocation of skills is performed by first identifying all available skills related to a particular issue. These skills may be related to the issue by any number of criteria, such as geography, account, competency, experience, frequency of use, time since last use, or the like. These criteria allow the system to dynamically reallocate available skills based on goals or other requirements, such as service level agreements (SLA) whereby service providers agree to deliver a certain level of service. The level of service or performance rating of an SLA in a help desk environment, for example, may be based on measurable factors, such as uptime (network or power), call abandon rate (percentage of calls abandoned while waiting to be answered), average speed to answer, first call resolution (percentage of calls answered without the need for a callback), or time service factor (percentage of calls answered within a set time). An example of a scenario invoking the reallocation of skills is a minimum manpower requirement whereby the system automatically shifts subject matter experts to areas or accounts having insufficient experts available to meet customer demand. Conversely, the system may also reallocate subject matter experts from areas having an excessive amount of available skills in order to increase efficiencies. By dynamically reallocating skills based on goals and service level requirements, the system helps to ensure that required levels of service are maintained across accounts and that system resources are optimized.

The system improves skill training and transition by more effectively summarizing roles. Roles may be summarized based on areas addressed, tools used, contacts, expertise, extent of reuse, efficiency, and the like. This affords role players (service providers or users) with a clearer definition of provider boundaries, responsibilities and skill requirements. The system also includes a role replay tool that allows roles to be replayed based on a specific problem, by time period, or other criteria. The role replay tool allows providers to replay previously successful solutions for a given problem. The replay tool may be utilized for resolving current problems and for training and transitioning service providers. Summarizing and replaying roles allows the system to catalog consistent and proven solutions to problems, as well as utilize those solutions later to resolve problems or as a training tool. These aspects of the system all help to ensure resiliency of skills and workforce by rapidly identifying and reallocating critical skills.

FIG. 1 illustrates an exemplary flowchart of the system of the present invention. The system includes skill capture tools 110, skill repository 120, skill analysis tools 130, and presentation and search tools 140. The skill capture tools 110 run on peripheral and end devices to automatically record specified activities. These peripheral and end devices are used by different providers and includes PCs, PDAs, various sensors, e.g., GPS and audio recorders. These activities are stored in a skill repository or knowledge base 120 for use by the system.

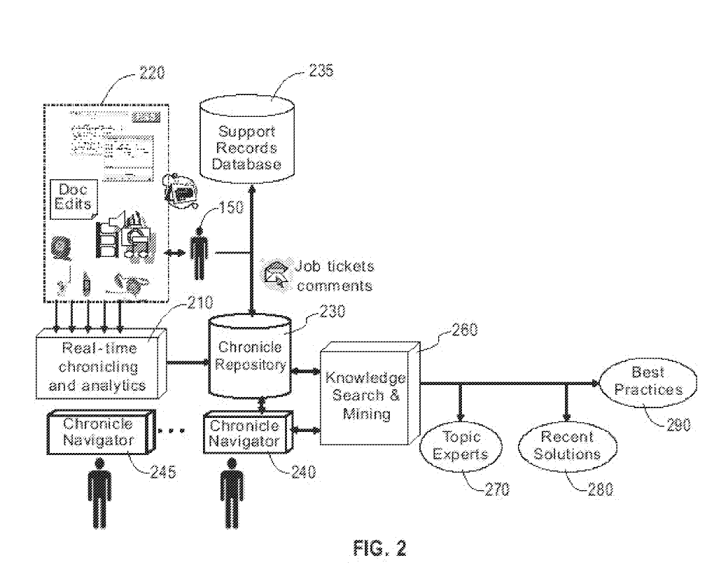

The skill repository 120 is in communication with skill analysis tools 130. The skill analysis tools 130 automatically associates the activities performed with the individual provider performing the activities. The skill analysis tools 130 dynamically chronicle and update the skill set associated with the individual providers, as well as the overall available skill set associated with the activities performed in the skill repository 120. The skill analysis tools 130 provide a means to automatically estimate the skills available in the skill repository 120. This estimation of skills is performed by several sources, including the analysis of reports and problem records, the automatic capture and analysis of user activities in specific areas, and the extent of re-use and ratings of user contributions by others in a shared network. These sources will be discussed further with respect to FIG. 2.

Skill analysis tools 130 are in communication with presentation and search tools 140. The presentation and search tools 140 allow the roles of service providers to be summarized and replayed. The summary of roles provides users with more clear and consistent definitions of roles. The replay of roles provides a reference to resolve current problems and a tool for training users to resolve problems in the future by utilizing previously successful solutions to specific problems.

FIG. 2 illustrates an exemplary system for capturing skills and activities as implemented in a help desk environment. The system includes various components and is designed to dynamically capture and replay the skills and activities of users or service providers. The present exemplary embodiment includes electronic chronicling tools 210, a set of annotation tools 220, a skills repository 230, chronicle navigators 240, 245, and a search and mining tool 260. While this system is described in regards to a help desk environment it is applicable to other business environments as would be recognized by those of ordinary skill in the art based on this disclosure.

The electronic chronicling tools 210 run on various peripherals and end-devices. These electronic chronicling tools 210 automatically log or capture selected activities as they are performed. The activity capture feature may be set to record various aspects of a business process, including, for example, the state of the business process, the type of application, the state of the application, the problem reported, the problem discovered, the extent of the problem, the resolution, the people involved, the tool(s) used, the geography, the time reported, the time resolved, as well as other indicators of the state and resolution of the problem. Once these aspects of the business process are captured, they are chronicled in a skills repository 230 for use by the role replay and training system. The skills repository 230 may be, for example, a database, such as a relational database, a structured repository, or the like. The skills repository 230 may also be in communication with another database 235 that stores additional information for use by the role replay and training system. This additional information may include job tickets, reports, records, logs, and other diagnostics generated by users or the system. The capture of this additional information may typically be initiated and terminated by the user or automatically generated by the system.

A set of annotation tools 220 are arranged to communicate with the electronic chronicling tools 210 and the skill repository 230 to allow users to “bookmark” moments during the processes and to optionally provide additional annotation on these bookmarks. These annotations may include audio/voice clips, text notes/messages, and other memos. The annotation tools 220 capture the context of the problem and/or resolution in real-time and allow the users to supplement the bookmarks with other comments. These bookmarks and comments provide the system with more meaningfully relevant detail about the problems and resolution and ultimately the skills that may be utilized to resolve the problems.

The electronic chronicle repository 230 stores and organizes the temporal activity information received from the electronic chronicling tools 210. This activity information is stored and organized based on various contextual dimensions such as location and type of activity, across many role players. These role players include users and end-devices in the business process.

Chronicle navigators 240, 245 interface with the skill repository 230 and the search and mining tool 260. Chronicle navigators 240, 245 allow for the analysis (e.g., retrieval, sorting, isolation, and organization) and utilization of the information stored on the chronicle repository 230. The chronicle navigators 240, 245 allow users to control the type and manner in which data from the chronicle repository 230 and search and mining tool 260 is analyzed and/or utilized. For example, the chronicle navigators 240, 245 allow users to review the chronicled skills, perform searches, add annotations, as well as share the skills with other people 250.

Search and mining tool 260 is in communication with the chronicle repository 230 and chronicle navigators 240, 245 and continually updates the skills repository 230. Search and mining tool 260 perform several functions, including (a) skill extraction and association with individual activities, (b) clustering of chronicle activities into hierarchical skill groupings, (c) aggregation of skills across numerous individuals, and (d) analysis of skill aggregates to obtain key summary statistics. Search and mining tool 260 also enables users to perform a flexible and focused search and mining of chronicled skills along multiple search dimensions and at various levels of detail. The search and mining tool 260 outputs the search results based on user criteria. For example, when utilized to search the skills repository 230 for solutions to a particular problem the search and mining tool outputs solutions divided into relevant dimensions, such as subject matter experts 270, recent solutions used 280, and best practices 290.

Subject matter experts 270 include all service providers with the skill necessary to resolve a problem related to the topic of interest. The focus and flexibility provided by the search and mining tool 260 allows the results of the subject matter experts 270 to be adjusted along multiple dimensions, including for example, level/years of experience, certifications, ratings, availability, geography, and other user related criteria. Recent solutions 280 include all solutions related to the topic of interest over a specified period of time. Best practices include the modes of operation and solutions already determined to provide the best results for the problem of interest. The best practices 290 include a summary or replay of these solutions that the user can execute or automatically implement to resolve the current problem. The focus and flexibility provided by the search and mining tool 260 allows the results of the recent solutions 280 and best practices 290 to be adjusted along multiple dimensions, including for example, frequency of use, time since last use, success rate, and time required to implement. The search and mining tool 260 provides a means to narrow and broaden the searches of the subject matter experts 270, recent solutions 280, and best practices 290 as appropriate to satisfy particular needs. The results may be presented in text, audio or video and may be manually updated and shared by the user.

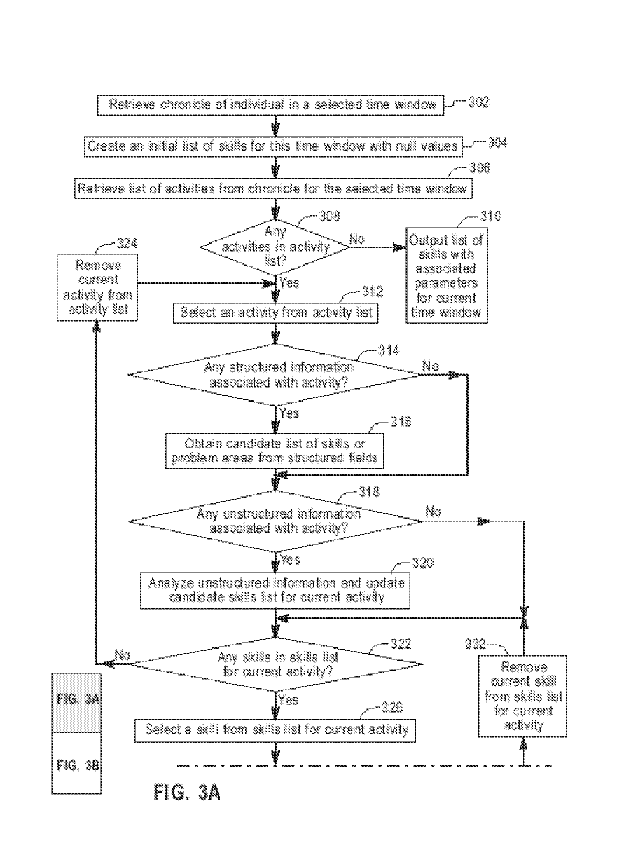

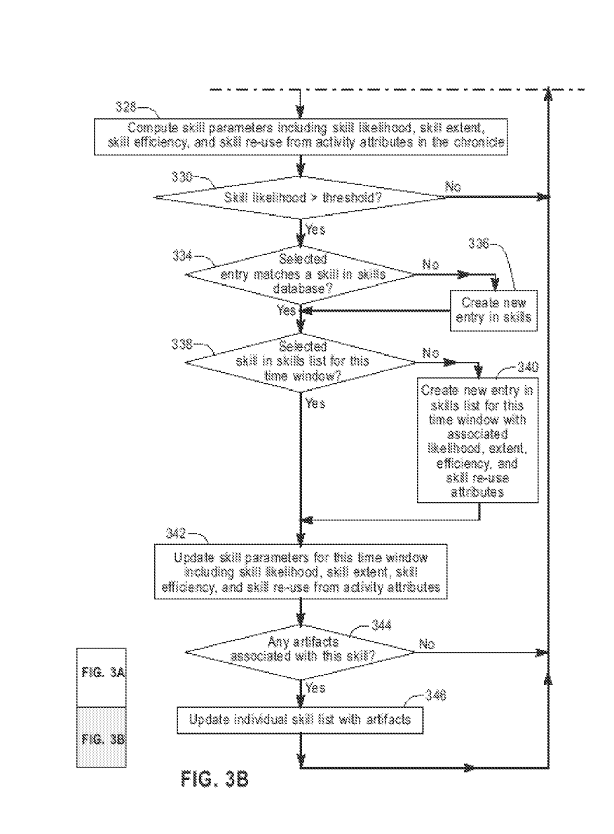

FIGS. 3A-B illustrate an exemplary skill extraction and activity association process performed by the search and mining tool of the present invention. The skill extraction and activity association process outlines how individual user skills are extracted from ongoing user activities and how those activities are then associated with the individual user skills. By accessing and analyzing the chronicle repositories of individuals, the search and mining tool extracts likely skills associated with each individual activity or time period of activity. The search and mining tool analyzes both “structured” and “unstructured” information captured in the chronicle to determine the skill associated with an activity. For example, in a help desk environment, as a user works on a problem, the chronicle maintains an unstructured record of the user's actions, including applications used, voice/chat transcripts, problem description notes, and other similar information. While the process is described with respect to skills related to an individual user, other skill associations may be used. For example, skills related to specific groups, organizations, applications, or time periods may be extracted, associated, and utilized by the system.

The chronicle also maintains specific structured information available in a problem ticket system such as problem category, sub-category, solution category, and other similar information. The unstructured information and structured information are both analyzed by the tool to associate a likely skill or set of skills with each activity. This analysis and association may result in a database, table or other representation that indicates the association of skills and activities. The database may include several definable categories, such as “Activity Time Period”, “Associated Problem Area/Skill”, “Likelihood of Association”, and “Associated Outputs/Artifacts”. For example, Activity Time Period indicates a specific period of interest. Associated Problem Area/Skill indicates the association of known problem areas and skills associated with resolving those problems. Likelihood of Association indicates the probability that the indicated skill will resolve the associated problem. Associated Outputs/Artifacts indicates the related outputs and artifacts associated with the particular area of interest, for example, skill, activity or time period. As discussed further below, values are assigned to each of these categories that define the association of skills and activities in a problem area and the probability or “likelihood” that these skills will resolve problems in that area.

The skill extraction and activity association process is illustrated in two parts in FIGS. 3A-B. The process begins, as shown in FIG. 3A, at 302 with the system retrieving chronicles of an individual in a selected time window. While the skill extraction and activity association process is described with respect to an individual and a selected time window, it may also be utilized with other selected skill associations, such as specific groups, organizations, or applications. At 304, the system creates an initial list of skills for the selected time window wherein the skills have no assigned values. At 306, the system retrieves a list of activities from the chronicle for the selected time window. At 308, the system determines whether there are any activities in the activity list. If there are no activities present in the activities list, the system proceeds to 310 and outputs a list of skills having associated parameters for the current time window. If there are activities present in the activities list, the system proceeds to 312 and selects an activity from the activity list.

At 314, the system determines whether there is any structured information associated with the selected activity. If there are no structured activities associated with the selected activity, the system proceeds to 318. If there are structured activities associated with the selected activity, the system proceeds to 316 and obtains a candidate list of skills or problem areas from the structured fields. At 318, the system determines whether there is any unstructured information associated with the selected activity. If there is no unstructured information associated with the selected activity, the system proceeds to 322. If there is unstructured information associated with the selected activity, the system proceeds to 320 and analyzes the unstructured information and updates the candidate skill list for the current activity.

Then, the system proceeds to 322 and determines whether there are any skills in the list for the current activity. If there are no skills in the list for the current activity, the system proceeds to 324 and removes the current activity from the activity list before proceeding to 312 to repeat the cycle. If there are skills in the list for the current activity, the system proceeds to 326 and selects a skill from the skill list for the current activity. The system proceeds to 328, shown in FIG. 3B, and computes skill parameters or ratings including skill likelihood (success rate), skill extent, skill efficiency, and skill re-use from activity attributes in the chronicle. At 330, the system determines whether the skill likelihood for the selected skill is greater than a threshold assigned by the system or user. If the skill likelihood is not greater than the threshold, the system proceeds to 332, shown in FIG. 3A, and removes the current skill from the skill list for the current activity and proceeds to 322, and repeats the cycle. If the skill likelihood is greater than the threshold, the system proceeds to 334 and determines whether the selected entry matches a skill in the skills database. If the selected entry does not match a skill in the skills database, the system proceeds to 336 and creates a new entry in the skills database. If the selected entry does match a skill in the skills database, the system proceeds to 338 and determines whether the selected skill is in the skills list for this time window. If the selected skill is not in the skills list for this time window, the system proceeds to 340 and creates a new entry in the skills list for this time window with associated likelihood, extent, efficiency, and re-use attributes. If the selected skill is in the skills list for this time window, the system proceeds to 342 and updates the skill parameters for this time window including, for example, skill likelihood, extent, efficiency, and re-use from activity attributes. At 344 the system determines whether there are any artifacts associated with this skill. If there are no artifacts associated with this skill, the system cycles back to 332, shown in FIG. 3A, and removes the current skill from the skill list for the current activity. If there are artifacts associated with this skill, the system updates the individual skills list with artifacts before cycling back to 332.

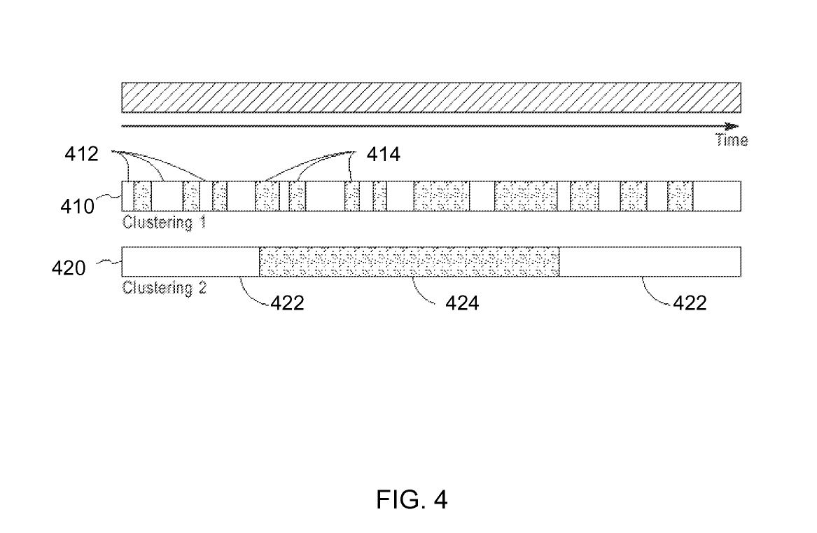

The search and mining tool executes the skill extraction and activity association process to identify, associate, and chronicle skills and activities. Once chronicled, these activities can be grouped into hierarchical skill “clusters”. This clustering of chronicled activities allows segmentation of the chronicle timeline with skills at different levels of granularity. FIG. 4 illustrates exemplary cluster bars used with an embodiment of the present invention. The system creates the cluster bars 410 by grouping and organizing chronicled activities organized by skills. Cluster bar 420 illustrates a higher level of cluster grouping wherein the clusters 422, 424 each represents a set of skills. The skill clusters illustrated on cluster bars 410, 420 are filtered into activity blocks that are distinguished by color or other differentiating means wherein related skills share a common color. For example, clusters 422 may represent all activities related to communication and cluster 424 may represent all activities related to research. While two groups are shown in this exemplary embodiment, the settings may be adjusted to indicate any number of activity groups representing related activities. The cluster bars 410, 420 provide a quick visual indication of the types and relative amounts of activities performed.

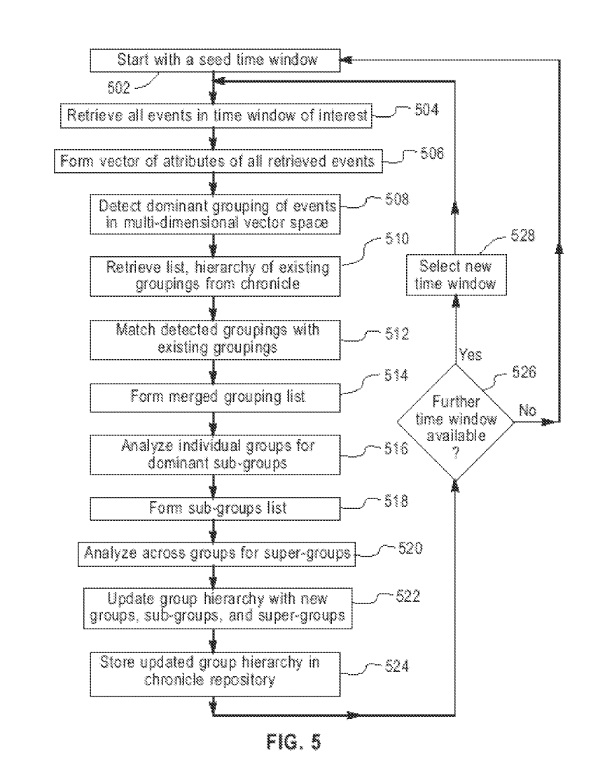

FIG. 5 illustrates an exemplary process for clustering chronicled activities into hierarchical skill groups. The clustering process starts at 502 with an initial time window of interest. At 504, the system retrieves all skills in the time window of interest. At 506, the system forms a vector of attributes of all retrieved skills. At 508, the system detects dominant groupings of skills in multiple dimensions (e.g., relevant time periods, skill areas, locations, activity types, and desired level of detail). At 510, the system retrieves a hierarchical list of existing skill groupings from the chronicle. At 512, the system matches detected groupings with existing groupings. At 514, the system merges the detected groupings with existing groupings to form a merged grouping list. At 516, the system analyzes individual groups for dominant sub-groups. At 518, the system forms a sub-groups list. At 520, the system analyzes across groups for super-groups. At 522, the system updates group hierarchy with new groups, sub-groups, and super-groups. At 524, the system stores updated skill group hierarchy in chronicle repository. At 526, the system determines whether there are more available time windows. If there are more time windows available, the system proceeds to 528 and selects a new time window before cycling back to 504. If there are no more time windows available, the system cycles back to 502.

The system may also perform aggregation of skills. Utilizing the analysis and categorization of the individual chronicles the system aggregates the potentially numerous individual skills. This aggregation yields composite statistics related to each skill area. The resulting statistics may be used to provide a database, table or other representation of skill aggregates. The table may include several definable categories, including “Skills/Problem Area”, “Associated Individual”, “Extent of Experience”, “Efficiency of Performance”, “Significant Outputs/Artifacts”, and “Extent of Re-use by Others”. For example, Skills/Problem Area indicates the problem area of interest and associated skills. Associated Individual indicates the individual users possessing the skills associated with the problem area of interest. Extent of Experience indicates the degree of experience of the individual users based on time spent (e.g., hours, weeks, or months) or other measures (e.g. education, training, or certifications) in the problem area. Efficiency of Performance indicates the efficiency with which the individual users resolve problems (e.g., average call handling time) in the problem area. Significant Outputs/Artifacts indicates the extent of experience of the individual users with recognized important outputs or artifacts associated with the problem. Extent of Re-use by Others indicates the frequency with which the skills of individual users have been used by other. The system also stores these “re-used” solutions and makes them available to others to solve the same or similar problems. Values are assigned to each of these categories that define the skill of the individual users associated with the problem areas of interest. This process allows the system to identify individual users that possess the necessary skills to resolve indicated problems and/or recent solutions to similar problems. These individual users and solutions may be identified via links, pointers or groupings.

The search and mining tool finds the skill categories in two ways. The first method includes matching structured and unstructured information in the chronicle with an existing database of known skills and/or problem areas. The second method includes discovering new likely categories from the chronicle of the individual based on the applications, artifacts used, and semantics of unstructured information. These discovered skill associations are then registered in a skills database that can be updated or over-ridden manually, when desired.

The search and mining tool interfaces with the chronicle to provide these outlined solutions, including providing inputs to the chronicle navigator and receiving outputs of the chronicle navigator. With respect to providing input to the chronicle navigator, as a user browses the chronicle of an individual through the chronicle navigator the user is provided with links, pointers, and groupings based on inputs from the search and mining tool. These links, pointers, and groupings, include more particularly (i) pointers to experts associated with an activity, (ii) pointers to other recent solutions associated with similar problems, and (iii) groupings of skills at different levels of abstraction enabling the user to zoom in and out of the chronicle in terms of skills at the desired level of detail. With respect to receiving output from the chronicle navigator, the chronicle records provide vital re-use data to the search and mining tool. The re-use data comes in both implicit and explicit form from the chronicle navigator. Implicit ratings come from the chronicle navigator logs, e.g., how much a particular user's chronicled activities and associated skills were accessed (and used) by others, particular chronicled artifacts accessed (and used) by others, the extent of re-use by others, and the extent that others recorded the activities, skills and artifacts in their own chronicle. The chronicle navigator also enables users to provide explicit ratings when accessing a particular skill, user, activity, or artifact. These explicit ratings are utilized in the aggregation and analysis of individual skills.

The invention can take the form of an entirely hardware embodiment, an entirely software embodiment or an embodiment containing both hardware and software elements. In at least one exemplary embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

Computer program code for carrying out operations of the present invention may be written in a variety of computer programming languages. The program code may be executed entirely on at least one computing device, as a stand-alone software package, or it may be executed partly on one computing device and partly on a remote computer.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

It will be understood that each block of the flowchart illustrations and block diagrams and combinations of those blocks can be implemented by computer program instructions and/or means. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions specified in the flowcharts or block diagrams.

The exemplary and alternative embodiments described above may be combined in a variety of ways with each other. Furthermore, the steps and number of the various steps illustrated in the figures may be adjusted from that shown.

It should be noted that the present invention may, however, be embodied in many different forms and should not be construed as limited to the embodiments set forth herein; rather, the embodiments set forth herein are provided so that the disclosure will be thorough and complete, and will fully convey the scope of the invention to those skilled in the art. The accompanying drawings illustrate exemplary embodiments of the invention.

Although the present invention has been described in terms of particular exemplary and alternative embodiments, it is not limited to those embodiments. Alternative embodiments, examples, and modifications which would still be encompassed by the invention may be made by those skilled in the art, particularly in light of the foregoing teachings.

Those skilled in the art will appreciate that various adaptations and modifications of the exemplary and alternative embodiments described above can be configured without departing from the scope and spirit of the invention. Therefore, it is to be understood that, within the scope of the appended claims, the invention may be practiced other than as specifically described herein.

We claim:

1. A data processing method, comprising:
retrieving captured activities from a database based on selected criteria;
determining skills associated with said activities;
determining parameters for said skills based on said activities; and
dynamically storing said updated skills in a database.

2. The data processing method according to claim 1, further comprising clustering said captured activities based on shared parameters.

3. The data processing method according to claim 2, wherein said captured activities are clustered into hierarchical skill groupings.

4. The data processing method according to claim 1, further comprising browsing said skills database for solutions to current problems.

5. The data processing method according to claim 4, wherein said browsing is performed at varying levels of abstraction.

6. The data processing method according to claim 4, wherein said solutions may be sorted based on subject matter experts, recent solutions, and best practices.

7. The data processing method according to claim 4, further comprising:
reusing said solutions to resolve a current problem, provide skills training, or to support the transitioning of skills resources.

8. The data processing method according to claim 7, wherein said reuse includes the replay of known solutions.

9. The data processing method according to claim 1, wherein said selected criteria is selected from a group consisting of: an individual, a group, an organization, an application, or a time period.

10. The data processing method according to claim 1, wherein said skills parameters include skill likelihood, skill extent, skill efficiency, and skill re-use.

11. The data processing method according to claim 1, wherein
said captured activities are performed by at least one user to resolve a problem, and
said captured activities are stored in a database.

12. A method for estimating and chronicling the skills of an individual, comprising:
retrieving captured activities from a database based on selected criteria;
creating a list of skills for said selected criteria;
determining skills associated with said activities;
determining parameters for said skills based on said activities;
updating said skills based on said parameters and associated activities; and
dynamically storing said updated skills in a database.

13. The data processing method according to claim 12, further comprising:
clustering said captured activities based on shared parameters, and
wherein said captured activities are clustered into hierarchical skill groupings.

14. The data processing method according to claim 12, further comprising:
reusing said solutions to resolve a current problem, provide skills training, or to support the transitioning of skills resources, and
wherein said reuse includes the replay of known solutions.

15. A system for estimating and chronicling the skills of an individual, comprising:
at least one database for storing captured activities;
means for obtaining selection criteria;
means for retrieving captured activities from said database based on said selection criteria;
means for determining skills associated with said activities;
means for determining parameters for said skills based on said activities; and
means for dynamically storing said updated skills in said at least one database.

16. A computer program product comprising a computer useable medium including a computer readable program, wherein the computer readable program when executed on a computer causes the computer to:
capture activities performed by at least one user to resolve said problem;
chronicle said captured activities; and
estimate the skill of said at least one user based on said captured activities.

17. A computer program product according to claim 16, wherein the computer readable program further causes the computer to:
dynamically chronicle said captured activities.

18. A computer program product according to claim 16, wherein the computer readable program further causes the computer to:
search said captured activities for solutions to current problems; and
utilize said search to resolve current problems.

19. A computer program product according to claim 18, wherein utilizing said search includes the training of service providers, the reuse of known solutions, and the reallocation of skills.

20. A computer program product according to claim 16, wherein the computer readable program further causes the computer to:
cluster said captured activities based on shared parameters, wherein said captured activities are clustered into hierarchical skill groupings.
